(19) United States
(12) Patent Application Publication
(10) Pub. No.: US 2005/0196223 A1
(43) Pub. Date: Sep. 8, 2005

(54) Letter opener writing instrument

(76) Inventor: Marko Stankovic, Buffalo, NY (US)

Correspondence Address: PATRICIA M. COSTANZO, PATENT COPYRIGHT TRADEMARK LAW, 2960 BOWEN ROAD, ELMA, NY, 14059, US

(21) Appl. No.: 10/791,583

(22) Filed: Mar. 2, 2004

(51) Int. Cl. B43K 29/00

(52) U.S. Cl. 401/195

(57) ABSTRACT

A letter opener writing instrument device comprising a writing instrument, a pocket clip affixed to the instrument, and a cutting edge operatively positioned between the instrument and pocket clip providing for the cutting of paper by the device. The device may further comprise a spacer and/or a stopper, both affixed between the instrument and the pocket clip, where the spacer may provide space and/or an attachment mechanism and the stopper limits accessibility to the cutting blade preventing damage to a shirt pocket or the like. The pocket clip cutting unit may be provided as a separate unit for its detachable attachment to a writing instrument. A writing instrument may be a fountain pen, ball point pen, mechanical or non-mechanical pencil, marker, and stylii, such as are used with touch-sensitive screens. The sleek, slim design, of the instrument provides for its attractive and comfortable insertion into a shirt pocket.

### CROSS-REFERENCE TO RELATED APPLICATIONS

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates to paper cutters and more particularly, the present invention relates to a paper cutter that is able to perform as a letter opener which is part of a writing instrument.

The background information discussed below is presented to better illustrate the novelty and usefulness of the present invention. This background information is not admitted prior art.

Letter openers are available in many sizes and styles. The most popular style offers an elongated blade extending several inches from a holding means. The distal end of the blade conventionally has a point tapered to fit in an opening of an envelope. The cutting edge of the blade element is of varying sharpness as the blade can be formed of metal, but can also be formed of other materials, such as plastic, for example. Once the tapered point is placed under the flap of the envelope, the blade is forced through the fold of the envelope's flap, thus opening the envelope for inspection of its contents.

Letter openers provide for rapid and easy opening of various types of envelops and other types of mail. Letter openers also provide for envelopes to be opened neatly, eliminating the messy bits of protruding paper that usually result when an envelope is opened without the benefit of a letter opener. Despite the advantages they offer, letter openers are often conspicuously absent from a letter opening area. Letter openers are frequently found on well-appointed desks, but are often not found in areas of the home or workplace where a letter is most likely to be opened. As people arrive home from work they often collect their mail on their way into the home and sit down at the kitchen table or on a favorite easy chair to read their mail. These are places, however, where a letter opener is likely to be found. Likewise, when mail arrives at the office, even though there might be a dedicated mail handling person, who might be equipped with a letter opener, it is more likely that the sorted but unopened mail will be delivered to an addressee's desk where it is more likely then not that a letter opener will not be found. Even if all employees are issued a letter opener at the beginning of their employment the openers are soon misplaced or lost. In either case, at home or at work, when there is mail to be opened and no letter opener is at hand the person opening the mail may resort to using objects not designed to open letters, possibly resulting in excessive tearing of the envelope, damage to the contents of the envelope, and/or injury to the person opening the letter. The desirability of having a letter opener handy when and where it is needed is, thus, easily appreciated. Also appreciated is that letter openers are useful in ways other than opening envelopes.

Many people enjoy the monetary savings afforded by the use of redemption-type coupons. Usually such coupons are made ready for a shopping trip while a shopper is at home. Occasionally, however, a shopper comes across a coupon offer when away from home, while at work, for instance. If, for instance, the unexpected discovery of a cost-saving coupon results in a shopping trip on the way home from work to redeem the coupon, the coupon may still be attached to the newspaper, magazine, or advertising flyer in which the coupon was first seen. It is not to be expected that a pair of scissors would be handy at such an time, yet tearing the coupon away from the page on which it is printed could result in tearing the coupon and, thus, invalidating it for redemption. It is easy to understand how useful it would be to have a paper cutting instrument available for use.

Unlike letter openers, writing instruments, such as pens and pencils, are frequently found in many areas of the home, at work, in a motor vehicle, as well as in one's purse or briefcase, such as felt-tipped markers, wood and plastic pencils, mechanical pencils. More particularly, writing instruments, such as ball point pens, fountain pens, and retractable ink pens are likely to be found on people's desks or on, or near, a kitchen table or work area. In fact, it is nearly inconceivable that an office or a kitchen would not have a multitude of writing instruments. Moreover, most people carry a writing instrument on their person, or at least in their briefcases, schoolbags, or purses.

Therefore, it seems obvious that what is sorely lacking in the art is a letter opener which is attachable to, or otherwise formed with, a writing instrument in order to alleviate the inconveniences of using separate letter openers and writing instruments.

While there have been some efforts to provide for a writing instrument that also functions as a letter opener, none of these efforts has been successful in producing a writing instrument letter opener device that is able to function like a typical writing instrument. Due to the fact that the paper cutting element of the letter opener part is located on a wing-like extension that is either reversibly attached to an instrument or is formed as a wing-like extension of the pen barrel, these devices are bulky and awkwardly shaped. Thus, these devices are also heavier than a conventional pen and when placed in a front pocket of a shirt, the wing-like extension of the device would likely protrude from the pocket in an unattractive manner. Moreover, because of their bulk if these devices were to be placed in an ordinary pen or pencil jar they either would not fit or if they did fit they would likely become tangled with other pens or pencils in the jar. Similar problems would be encountered if one wanted to carry one of these oversized devices in one's purse or bag. Also, if made of a brittle material such as a hard plastic, the wing-like extensions are likely to be prone to breaking.

Another attempt to provide for a letter opener writing instrument comprises a letter opening device designed to be detachably positioned about a writing instrument. The letter opening device comprises a pair of gripping members or fingers forming a ring-like part to hold the device about a pen. The device also comprises an elongated member that depends from the ring-like part, the function of which is to engage the pen to a pocket, a belt, or the like. The distal end of the depending member is provided with cutting blade containing member. This unit is for use only on pens or pencils that are not equipped with a pocket clip; else the positioning of the cutter unit on the pen or pencil would be hindered by the presence of the pocket clip. Furthermore, in order for the cutting blade to be of useful size, the blade containing member must be large enough to protectively house the cutting blade, thus making the combination pen and letter opener bulky and unattractive, especially for those compelled to maintain a certain expected appearance. Additionally, because of the manner by which the cutting blade is fitted into the blade containing member, the device is not able to perform as a paper cutter, other than an envelop opener. Another problem inherent in this device is that there is no way to prevent the cutting blade from accidentally cutting material that is not meant to be cut, such as the lining of a jacket when the jacket is worn over the shirt with the pocket containing the pen.

Yet another effort, while more successful in maintaining the sleek shape of a pen while providing for a cutting blade to be associated with the writing instrument, requires the writing instrument to have an inner and an outer barrel. The inner barrel is operatively adapted to accommodate a cutting element and the outer barrel, while relatively of standard shape has an opening on one side to provide access to the cutting element housed in the inner barrel and also has a somewhat larger barrel circumference to accommodate the inner barrel. This intricate design coupled with the fact that each instrument requires an outer barrel and a modified inner barrel along with a cutting element increases both the likelihood of breakage and the cost of manufacture.

Notwithstanding the attempts described above, it is clear that there is still no device that offers the convenience of a letter opener writing instrument, that can be safely attached to a piece of clothing or the like without fear of cutting the clothing material, that offers the sleek, thin, attractively designed barrel of a fine pen or pencil, that is sturdy and of simple construction, while maintaining affordable manufacturing costs.

### SUMMARY

The present invention satisfies the heretofore unmet needs in the art by setting forth a novel device that provides for a sleek, thin, attractively barreled, easy to use, and convenient-to-carry letter opener writing instrument. The device may be made out of any suitable material such as a fine metal or an inexpensive plastic, allowing the device to be as affordable or as expensive as desired. The device may comprise any type of writing instrument. The term writing instruments, of course, includes fountain pens, ball point pens, mechanical or non-mechanical pencils, markers, or stylii that are used to make a mark in form of an impression on contact. In addition to being used to open mail, the cutting means may be used to cut paper, such as cutting out important news articles, restaurant or entertainment reviews, theater schedules and address, and cost-saving coupons, for example. Moreover, because of its sleek, slim design the device can be safely and comfortably inserted into a shirt pocket and held there firmly by the device's pocket clip. Additionally the device may be conveniently carried in one's purse or briefcase.

The letter opener unit may be either an integral part of the writing instrument or, alternatively, it may be produced as a separate device that may be reversibly attached to any type of writing instrument. The cutting element of the device when it is produced as a separate unit is provided as an integral part of a pocket clip unit.

Pocket clip units are frequently attached to the case of a writing instrument by small metal bands sometimes referred to as clip bands. Clip bands may form a continuous band that is to be fitted over one end of the instrument. Alternatively, a clip band may be formed as a discontinuous band, that is, where the band has a slit in it. This configuration gives the band the ability to be fitted around a larger size range of devices. Pocket clip units are provided with an elongated finger that extends, in many instances, from the ring that is affixed to the barrel of a writing instrument. The elongated finger or clip arm, that is used to attach a writing instrument to a shirt pocket, often has a contoured protrusion on its distal end. To secure the letter opener writing instrument to a shirt pocket, or the like, the contoured protrusion of the clip arm of the pocket clip is slipped over the front piece of the pocket with the writing instrument typically, but not always, inserted inside of the pocket.

The letter opener part of the letter opener writing instrument comprises a pocket clip unit and a small cutting element located in the area of attachment between the pocket clip unit and the writing instrument barrel so that the cutting element is functionally positioned between the outer surface of the case of the writing instrument and the surface of the arm of the pocket clip unit that faces the surface of the case.

The length of the inner face of the clip arm and the opposing surface of the writing instrument's barrel defines an envelope accepting channel to guide an envelope toward the cutting element. To use the letter opener writing instrument, the distal end of the clip arm of the pocket clip is slipped into an opening defined by the front face of an envelope and the envelope flap to guide the envelope through the envelop accepting channel to the cutting element where the envelope is slit open by the cutting element to disclose the contents of the envelope. Alternatively, the top edge of an envelop may be guided by the envelop accepting channel to the cutting element where by pulling the top edge of the envelope along the cutting element, the top edge of the envelope is neatly sliced off, thus opening the envelop to disclose its contents.

Accordingly, this invention provides for a letter opener writing instrument device, comprising:
i) a writing instrument having a case, body, or barrel;
ii) a pocket clip unit affixed to the writing instrument, and
iii) a cutting element operatively attached to the writing instrument between the writing instrument and the pocket clip unit forming a pocket clip cutting element unit providing for paper to be cut by the letter opener writing instrument.

The letter opener writing instrument device may also further comprise a spacer that may be affixed to or formed as part of the pocket clip unit or, alternatively, may be affixed to or formed as part of the case of the instrument. The spacer may also be used as a support for the pocket clip unit.

The pocket clip unit may be fixedly attached to the case, barrel, or body of the instrument, or alternatively the pocket clip unit may be reversibly affixed to said case.

The letter opener writing instrument device may further comprise a stopper affixed either to the writing instrument or to the pocket clip to limit accessibility to said cutting blade. More particularly, the stopper provides protection against any damage that might otherwise be caused if a shirt pocket, or the like, came into contact with the cutting blade.

The letter opener writing instrument device additionally comprises a contoured protrusion affixed to a distal end of said pocket clip unit. This protrusion is to provide for the smooth insertion of the pen clip over a shirt pocket.

Furthermore, the pocket clip cutting element unit of the letter opener writing instrument comprises:
i) a pocket clip arm, said pocket clip arm having a first end, a second end, and a first surface;
ii) a band to be fitted about a writing instrument, where a section of the band is functionally attached to the pocket clip unit proximate to said first end of said pocket clip arm;
iii) the cutting element is functionally attached to the first surface of the pocket clip arm proximate the first end of the pocket clip arm, wherein the pocket clip cutting element unit may be reversibly positioned about the writing instrument providing for a letter opener writing instrument.

Additionally, a stand-alone pocket clip cutting element unit is also provided, comprising:
i) a pocket clip arm, the pocket clip arm having a first end, a second end, and a first surface;
ii) a band for reversible placement about a writing instrument, the band functionally attached to the pocket clip arm proximate to the first end of the pocket clip arm;
iii) a cutting element functionally attached to the first surface of the pocket clip arm proximate the first end of the pocket clip arm,
wherein the pocket clip cutting element unit is reversibly positionable about a case of the writing instrument providing for a letter opener writing instrument.

The simple design of the device ensures a low manufacturing cost as well as ease of use. The device is small and lightweight and can be easily packaged for display and sale. The device can be fabricated in any desired size and may be made of any material having the properties desired, such as plastic, fiberglass, ceramic, wood, glass, or metal.

### BRIEF DESCRIPTION OF THE DRAWINGS

In order that these and other features and advantages of the present invention may be more fully comprehended and appreciated, the invention will now be described, by way of example, with reference to specific embodiments illustrated in the drawings and specific language will be used to describe the same. It should, nevertheless, be understood that no limitations of the scope of the invention are thereby intended, such alterations and further modifications in the illustrated device and such further applications of the principles of the invention as illustrated therein, being contemplated as would normally occur to one skilled in the art to which the invention pertains.

FIG. 1 is a side plan view of a preferred embodiment of the letter opener writing instrument device according to the present invention.

FIG. 2 is a plan view of the letter opener writing instrument device rotated 90 degrees to show a top view of the letter opener writing instrument device showing that the sleek styling and thin physical attributes expected from a fine writing instrument are inherent in the letter opener writing instrument device made according to the principles of the present invention.

FIG. 3 is another side plan view to illustrate the addition of a stopper to limit accessibility to the cutting element.

FIG. 4a is a perspective stylized view of a preferred embodiment showing a streamlined, fashionable letter opener writing instrument made according to the principles of the present invention.

FIG. 4b is a slightly exploded view of the pocket clip end of the letter opener writing instrument to provide another view of the positioning of the cutting element and also to illustrate a detachably attached pocket clip cutting unit.

### DEFINITIONS

“Case” as used herein refers to the body of a writing instrument or the like. The case is also referred to as the body or barrel part of the instrument. In some models of writing instruments the case may comprise a first part and a second part where the first part of the case may be separated from the second part of the case to access the functional part of the instrument. The case may be removable, while in other models the case may not be removable.

A List of the Reference Numerals and the Parts of the Invention to which the Reference Numerals Refer

10 Letter opener writing instrument device.
12 Barrel, case, or body of letter opener writing instrument device 10.
12a One case or body section.
12b A second case or body section.
14 Writing end of exemplary letter opener writing instrument device 10.
16 Optional point actuating button of exemplary device 10.
20 A pocket clip unit which may or may not include cutting element 30.
22 Pocket clip spacer; also referred to and used as a support, if desired.
24 Optional contoured protrusion at distal end of pocket clip arm 28.
26 An attachment band of pocket clip unit 20.
26b A detachable attachment band.
28 Arm of pocket clip unit 20.
30 A cutting element.
40 A stopper limiting accessibility to cutting element 30 to prevent contact between the cutting element and the material of a shirt pocket or the like.
50 A preferred embodiment of a letter opener writing instrument device make according to the principles of the invention disclosed herein.

It should be understood that like reference characters indicate like parts throughout the several figures and that the drawings are not necessarily to scale. In certain instances, details which are not necessary for an understanding of the present invention, or which render other details difficult to perceive, may have been omitted.

### DETAILED DESCRIPTION

It should be appreciated that the disclosed invention is disposed to embodiments in many various sizes, shapes, and forms, such as large, medium, and small, thin and thick, long and short to accommodate various needs or desires. For example, large handed persons would likely appreciate a larger, longer, wider letter opener writing instrument device, whereas persons with small hands would likely be more comfortable with a smaller device that is easily held in their hands. Additionally, the device comes in a variety of shapes and forms to accommodate a variety of writing instruments, such as pencils, pens, markers, and the like. Today's market demands variety and choice, such as writing instruments in geometric shapes, helical type shapes, and all sorts of free form shapes. Some of these shapes are merely amusing or decorative, but others are functional in that they reduce hand strain or increase one's ability to maintain a firm grasp on the device. Therefore, the embodiments described herein are provided with the understanding that the present disclosure is intended to be simply illustrative and does not limit the invention to the embodiments described.

The present invention resides in a letter opener writing instrument that may also be used to perform paper cutting operations. As used herein, the phrase writing instrument is intended to broadly encompass those devices having marking and/or non-marking tips, such as pencils, ball-point, gel ink and rolling ball pens, fountain pens, felt markers, highlighter pens and markers, and stylii, such as are used with touch-sensitive screens.

The letter opener writing instrument according to the teachings of the present invention has a body comprising a barrel or case that usually provides accommodation for the writing mechanism. The barrel or case may comprise a single unit or may consist of parts that may be reversibly secured to each other. A pocket clip unit for securing the writing instrument to a shirt pocket, pad of paper, belt, or the like is secured to the cap or barrel of a writing instrument and typically comprises a dip arm having a small curved or angled protuberance at the end to aid in sliding the dip arm over the edge of a pocket, or the like. To provide a secure grasp of the pen to a shirt pocket, the dip arm may be biased toward the body of the device. There are many methods of biasing a dip arm. One example comprises simply bending the strip of metal that forms the clip arm into a U-shape, thus providing an action that is similar to a leaf spring. To secure the letter opener writing instrument to a shirt pocket, the arm of the pocket clip is inserted over the front piece of the pocket with the writing instrument typically, but not always, inside the pocket.

The letter opener writing instrument also comprises a cutting element operatively positioned between the pocket clip arm and the writing instrument body in the area in which the pocket clip unit is attached to the writing instrument. An envelop accepting channel is defined by the length of the inner face of the clip arm and the opposing surface of the writing instrument's barrel. The envelop accepting channel guides an envelop to be opened to the cutting element.

The letter opener writing instrument is used as an envelope opener by slipping the generally tapered end of the clip arm between the flap of a sealed envelope and the front panel of the envelop. The clip arm acts as a guide to feed the part of the envelope to be cut into the paper accepting channel where it is directed to the cutting element to be opened. Alternatively, the top edge of an envelope, or any other type of paper that needs to be cut, such as a coupon that needs to be cut out of a magazine, for example, may be guided through the envelope accepting channel to the cutting element whereby pulling the top edge of the item to be cut along the cutting element, the edge of the item is neatly sliced, thus opening the envelop to disclose its contents or freeing the coupon for use.

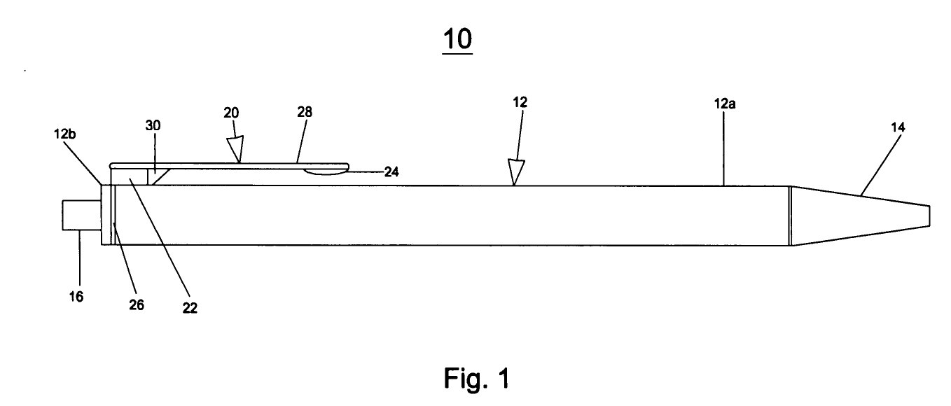

Referring now, with more particularity, to the drawings, FIG. 1, a side plan view of a preferred embodiment of the letter opener writing instrument device, illustrates device 10 including barrel 12 which, in this example, is comprised of extended upper barrel section 12a and shortened lower barrel section 12b, which sections may be separable from each other. Device 10 further comprises functional end 14, and, in this example, point actuating button 16. Of course, as is well known in the art, writing instruments may, or may not, have a point actuating button. Writing instruments may alternatively have a barrel turning mechanism to provide point actuation, while others may have a spring device that may be actuated by pressing on the clip arm, for example, while still other writing instruments have no actuation mechanism as their functional point is always accessible. Pocket clip unit 20 comprises clip arm 28 including contoured protrusion 24. In the example illustrated, clip arm 28 extends generally parallel to the side of barrel 12 and is arranged so that contoured protrusion 24 is positioned to be touching or nearly touching barrel body 12.

In the embodiments exemplified in FIGS. 1-3, pocket clip unit 20 is fixedly attached to writing instrument device 10 via dip arm support 22 which may be operatively attached to writing instrument body 12 by means of pocket clip attachment band 26. In this example, pocket clip attachment band 26 is positioned about instrument 10 between barrel section 12a and barrel section 12b and support 22 is fixedly secured to the device between attachment band 26 and clip arm 28. There are, of course, various other ways that pocket clip unit 20 may be affixed to device 10. For instance, in some embodiments, support 22 may be formed integral as a unit with clip arm 28, which unit may then be operatively affixed to a part of instrument 10. This configuration is often seen on pens that have covers, where the support/clip arm unit is attached to the pen's cover. In other configurations, the support part is formed integral with the cover where the support is used as a means to attach the clip arm to the cover.

In addition to providing a means for dip arm 20 to be attached to writing instrument 10, clip arm support 22 operates to provide a space or gap between clip arm 28 and writing instrument body 12. As in a conventional writing instrument, the gap created by clip arm spacer 22 serves, at least in part, to provide the space required for the material of the shirt pocket, or the like, to fit between clip arm 28 and writing instrument body 12 when the device is carried in and supported by a shirt pocket or by some similar item.

Some writing instruments avoid the need for a spacer by shaping clip arm 20 to have a curve or bend, which curve provides for a space between the clip arm and the writing instrument body. Notwithstanding the means used to attach the pocket clip to the writing instrument, the structural configuration of the clip arm, or the structural configuration of the barrel of the writing instrument part of the invention, the principle of the present invention is to provide a letter opener/paper cutting writing instrument that has a cutting element positioned between the clip arm and the body portion of a writing instrument, to provide for the effective opening of an envelope and/or the cutting of paper.

As illustrated, cutting element 30 provides for the cutting of paper, as in the opening of an envelope, and is functionally positioned between clip arm 28 and body 12 within the space created, in this example, by clip arm spacer 22. The spatial relationship between clip arm 28 and body 12 additionally makes available an envelope accepting channel for guiding the envelope or other paper to the cutting element. Cutting element 30 comprises a metal razor blade-like cutting edge or any other similarly functioning element that is equipped with a sufficiently sharp edge to cut paper.

As discussed above, clip arm unit 20 and cutting element 30 may be fixedly attached to writing instrument 12, or alternatively, clip arm unit 20 and cutting element 30 may be formed together as a separate unit to be reversibly attached to any writing instrument. Providing clip arm 28 and cutting element 30 as a separate unit is especially useful when the unit is to be fitted over a writing instrument that is not equipped with a clip arm unit.

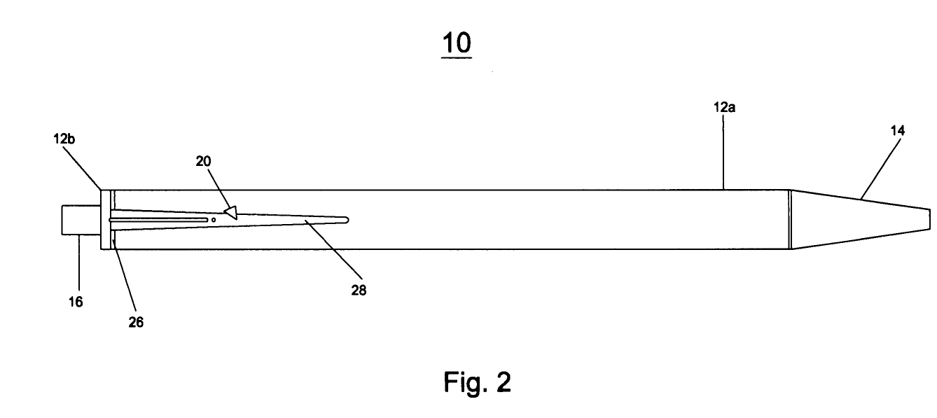

FIG. 2, a top plan view of the writing instrument, illustrates that the addition of a cutting element between the pocket clip unit and the opposing surface of a surface of the writing instrument according to the teachings of the present invention does not change or detract from the sleek appearance or physical slimness expected in a fine writing instrument.

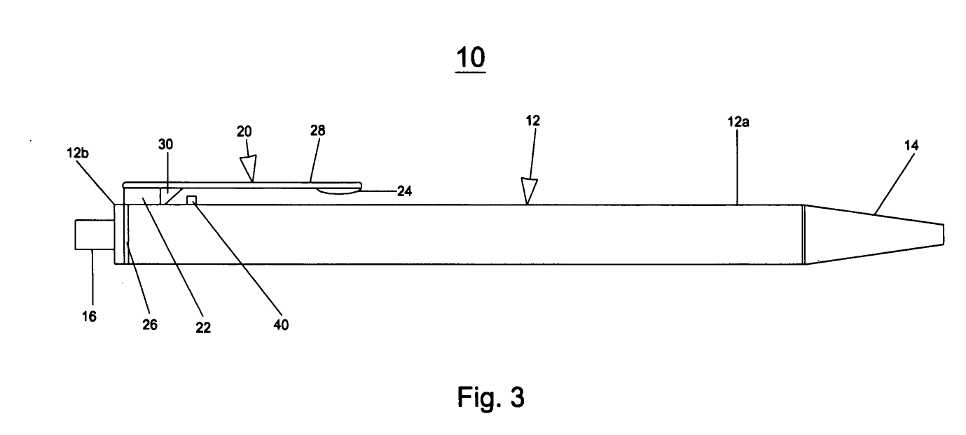

FIG. 3 illustrates the addition of stopper 40 to writing instrument 10 for the purpose of limiting access to the cutting element to prevent the cutting element from coming into contact with shirt pocket material, or the like. Stopper 40 may be made of any suitable material that will not interact adversely with the material of a shirt, a belt, or the like. Thus, stopper 40 may be constructed of materials, such as plastic, rubber, metal, wood, or the like and may be attached to the body of the letter opener writing instrument, as illustrated or, alternatively, stopper 40 may be affixed to the inside surface of clip arm 28. When the letter opener pocket clip unit is manufactured as a separate, free-standing, replaceable unit, then the stopper must, of course, be affixed to the clip arm.

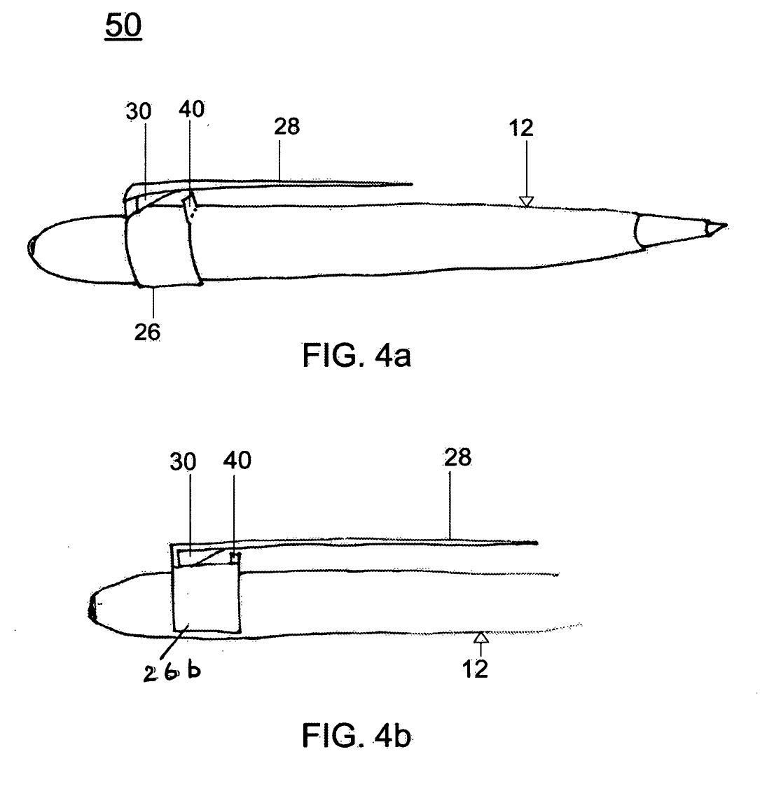

FIG. 4a is a perspective view of a preferred embodiment 50 of the present invention showing a letter opener writing instrument with body case 12 made according to the principles of the present invention. The letter opener writing instrument device, as illustrated, is as handsome, streamlined, slender, and fashionable as could be expected from any fine writing instrument, and yet is able to operate as an envelope guide, a letter opener, and a paper cutter. This style letter opener writing instrument device avoids the need for a spacer/support by having clip arm 28 that is attached to attachment band 26 shaped so that the arm is directed a functional distance away from the writing instrument body. The device has cutting element 30 positioned between clip arm 28 and body portion 12 to provide for the safe, effective opening of an envelope. The letter opener writing instrument also includes stopper 40 functionally positioned on attachment band 26 between clip arm 28 and body portion 12 of the writing instrument. Stopper 40 limits access to the cutting element to prevent the cutting element from coming into contact with shirt pocket material or the like.

FIG. 4b, a slightly enlarged view of preferred embodiment 50 provides another view of the relationship between pocket clip 28, cutting element 30, and stopper 40. Additionally, FIG. 4b shows one way to reversibly attach the pocket clip unit to the writing instrument, which in this example is the use of discontinuous attachment band 26b.

The foregoing description, for purposes of explanation, uses specific and defined nomenclature to provide a thorough understanding of the invention. However, it will be apparent to one skilled in the art that the specific details are not required in order to practice the invention, as has been discussed above. Thus, the foregoing descriptions of specific embodiments are presented for purposes of illustration and description. They are not intended to be exhaustive or to limit the invention to the precise forms disclosed. Furthermore, the present invention is not limited to the described methods, embodiments, features or combinations of features but includes all the variation, methods, modifications, and combinations of features within the scope of the appended claims. Thus, the invention is limited only by the claims.

1. A letter opener writing instrument device, comprising:
i) a writing instrument having a case;
ii) a pocket clip unit affixed to said writing instrument, and
iii) a cutting element operatively attached to said device, said cutting element positioned between said writing instrument and said pocket clip unit providing for paper to be cut by the letter opener writing instrument.

2. The letter opener writing instrument device, as recited in claim 1, further comprising a stopper affixed to said writing instrument thereby limiting accessibility to said cutting element.

3. The letter opener writing instrument device, as recited in claim 2, further comprising said stopper affixed to said pocket clip unit.

4. The letter opener writing instrument device, as recited in claim 2, further comprising said stopper affixed to said case.

5. The letter opener writing instrument device, as recited in claim 1, said device further comprising a spacer positioned between said writing instrument and said pocket dip unit.

6. The letter opener writing instrument device, as recited in claim 5, further comprising said spacer attached to said pocket clip unit.

7. The letter opener writing instrument device, as recited in claim 5, further comprising said spacer attached to said case.

8. The letter opener writing instrument device, as recited in claim 1, further comprising said pocket clip unit fixedly attached to said case.

9. The letter opener writing instrument device, as recited in claim 1, further comprising said pocket clip unit reversibly attached to said case.

10. The letter opener writing instrument device, as recited in claim 1, further comprising a contoured protrusion affixed to a distal end of said pocket dip unit.

11. The pocket clip cutting element unit, as recited in claim 1, further comprising:
i) a pocket clip arm, said pocket clip arm having a first end, a second end, and a first surface;
ii) means for attaching said pocket clip arm to said writing instrument;
iii) said cutting element functionally attached to said first surface of said pocket clip arm proximate said first end of said pocket clip arm,
wherein said pocket clip cutting element unit is positionable about said writing instrument providing for a letter opener writing instrument.

12. The pocket clip cutting element unit, as recited in claim 11, further comprising a stopper wherein said stopper is functionally attached to said clip arm between said cutting element and said second end of said pocket clip arm, therein limiting accessibility to said cutting element.

13. The pocket clip cutting element unit, as recited in claim 11, further comprising a stopper wherein said stopper is functionally attached to said case between said cutting element and said second end of said pocket clip arm, therein limiting accessibility to said cutting element.

14. The device, as recited in claim 11, wherein said pocket clip arm is fixedly attached to said means for attachment.

15. The device, as recited in claim 11, wherein said pocket clip arm is reversibly attached to said case.

16. A pocket clip cutting element unit for use with a writing instrument, comprising:
i) a pocket clip arm, said pocket clip arm having a first end, a second end, and a first surface;
ii) means for attaching said pocket clip arm to said writing instrument;
iii) a cutting element functionally attached to said first surface of said pocket clip arm proximate said first end of said pocket clip arm,
wherein said pocket clip cutting element unit is positionable about said writing instrument providing for a letter opener writing instrument.

17. The pocket clip cutting element unit, as recited in claim 16, wherein said pocket clip cutting element unit further comprises a contoured protrusion positioned on said first surface of said pocket clip arm at said second end of pocket clip arm.

18. The pocket clip cutting element unit, as recited in claim 17, further comprising a stopper wherein said stopper is functionally attached to said clip arm between said cutting element and said contoured protrusion, said stopper thereby defining accessibility to said cutting element.

19. The pocket clip cutting element unit, as recited in claim 16, wherein said pocket clip cutting element unit further comprises a spacer, said spacer fixedly attached to said first end of said pocket clip arm.

20. A letter opener writing instrument device, comprising:
i) a writing instrument;
ii) a pocket clip functionally affixed to said writing instrument; and
iii) a cutting element operatively positioned between said writing instrument and said pocket clip therein providing means for paper to be cut.
